(19) United States
(12) Patent Application Publication
(10) Pub. No.: US 2007/0206864 A1
(43) Pub. Date: Sep. 6, 2007

(54) Method and System for Determining Compactness of an Object

(75) Inventors: Laurent Charlin, Montreal (CA); Li Zhang, Skillman, NJ (US); Jean Marc Peyrat, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/677,683

(22) Filed: Feb. 22, 2007

Related U.S. Application Data
(60) Provisional application No. 60/779,629, filed on Mar. 6, 2006.

(51) Int. Cl. G06K 9/62

(52) U.S. Cl. 382/224

(57) ABSTRACT

Disclosed is a method and apparatus for determining the compactness of a digital representation of an object. A kernel (which is smaller than the object itself) is positioned at the geographic center of the object. The kernel's dimensions are then uniformly expanded. A first radius of the kernel is determined when a portion of the kernel is first located outside of the object, A second radius of the kernel is determined when the kernel first overlaps the object. The compactness of the object is then determined using the first radius and the second radius.

This application claims the benefit of U.S. Provisional Application Ser. No. 60/779,629, filed Mar. 6, 2006, which is incorporated herein by reference.

### BACKGROUND OF THE INVENTION

This invention relates generally to digital image processing and more specifically to determining compactness of a digital representation of an object.

Digital images are electronic snapshots of, for example, documents such as photographs or manuscripts. The digital image is mapped as a grid of dots or picture elements. These grid of dots or elements are often referred to as pixels when the grid represents a two dimensional space and voxels when the grid represents three dimensional space. Each pixel is assigned a tonal value (black, white, shades of gray or color), which is represented in binary code (i.e., zeros and ones). The binary digits, or bits, for each pixel are stored in a sequence by a computer and often reduced to a mathematical representation. The bits are then interpreted and read by the computer to produce an analog version for display or printing.

A digital representation of an object (referred to herein as an object) is associated with a concept called compactness. Compactness is an intrinsic measurement of the geometrical property of an object, i.e., it is invariant to translation, rotation, and scaling. The compactness of a 2D object is often defined based on the values of perimeter and area of the object of interest, and 3D compactness can be defined as an extension of 2D compactness. For example, a circle or sphere is typically viewed as being very compact, and a long, single row of pixels, however, is often viewed as being much less compact than the circle or sphere.

Mathematically, compactness is typically defined in two dimensions (2D) as (p²/A) or in three dimensions (3D) as (Sa³/V²), where P is the perimeter of the object, A is its area, Sa is its surface area, and V is the object's volume. A problem with calculating compactness using the above equations, however, is that the equations do not compensate for noise in the image. Noise refers to distortion of the digital image. Noise can be introduced in a digital image during the conversion from an analog picture into a digital image. Noise can be present when, for example, the lines of an object in an image appear rough, jagged, or inaccurate. For example, a “smooth” object (i.e., a digital object with no distortion) has a particular surface area and volume. The same object with noise (i.e., distortion) present, however, may have a very large surface area or perimeter while having approximately the same volume as the smooth object. Since the two objects have approximately the same shape, their compactness should be equivalent. The noise, however, results in a different compactness for the noisy object relative to the smooth object.

One technique used to solve the problem of inaccurately determining compactness of an object when noise is present is called “discrete compactness”. Determining discrete compactness is a technique that eliminates the need to obtain the surface area of the objects. Specifically, discrete compactness has been calculated as described below.

The contact surface area Aₑ is defined as the sum of the areas of the contact surfaces which are common to two polyhedrons. Formally, discrete compactness is defined as

$$\frac{aFn - A}{2}$$

with a being the area of the face of the polyhedron (e.g., cubic voxels), F being the number of faces of the polyhedron (e.g., 8), n being the number of polyhedron in the volume, and A being the area of the enclosing surface. The final compactness is given by

$${C}_{D} = \frac{{A}_{C} - {A}_{C min}}{{A}_{C max} - {A}_{C min}} \qquad ( 1 )$$

where A_{C min} is defined as A_{C min}=A(n−1) or the contact surface of a line of voxels. On the other hand, A_{C max} is defined as

$${A}_{C max} = \frac{aFn - 6 a ( {\sqrt[3]{n )}}^{2} )}{2} \qquad ( 2 )$$

If using cubic voxels, this would be the contact surface area associated with a cube (the most compact surface for a given number of voxels). In the general case, the maximum area of the enclosing surface is therefore represented by the smallest element which makes up the volume. The normalization performed by equation 1 is used as an attempt to keep the compactness relatively invariant under scaling.

Discrete compactness, however, does not remain constant when an object is scaled. Scaling is when an object is resized. For example, if a smaller object needs to be scaled to, e.g., illustrate a portion of the object, the scaling of the small object can result in noise-like effects, resulting in a change in the object's compactness.

Therefore, there remains a need to measure compactness of an object while maintaining the compactness during scaling and/or when noise is present.

### BRIEF SUMMARY OF THE INVENTION

The current approaches to determining compactness are not satisfactory when the number of pixels or voxels used to represent a digital object (i.e., the object's resolution) is small or the object's contour is noisy because the current approaches often do not provide correct results.

In accordance with an aspect of the present invention, instead of relying solely on the shape of an object, compactness is determined by uniformly expanding a kernel inside the object. Specifically, a kernel (that is smaller than the object itself) is positioned at the geographic center of the object. The kernel's dimensions are then uniformly expanded. A first radius of the kernel is determined when a portion of the kernel is located outside of the object. A second radius of the kernel is determined when the kernel overlaps (i.e., encompasses) the object. The compactness of the object is then determined using the first radius and the second radius. If the kernel is a circle or sphere, each of the first and second radii is the radius of the circle or sphere. If the kernel is a square or cube, each of the first and second radii may be the length of a side of the square or cube.

In one embodiment, to determine compactness, the first radius is subtracted from the second radius, Compactness may alternatively (or additionally) be calculated by determining

$$\frac{{r}_{2}^{2}}{{r}_{1}^{2}} ,$$

where r₂ is the second radius and r₁ is the first radius.

Compactness may also be determined by calculating a minimum compactness and a maximum compactness. The minimum compactness may equal A, the area of the object. The maximum compactness may equal

$$\sqrt{\frac{A}{\prod }} .$$

Determining compactness can include determining a final compactness

$${C}_{KN} = \frac{{C}_{K} - {C}_{K min}}{{C}_{K max} - {C}_{K min}} , where {C}_{k} is \frac{{r}_{2}}{{r}_{1}} , {C}_{k min}$$

is the minimum compactness, and Cₖₘₐₓ is the maximum compactness. The final compactness may also be computed as

$${C}_{KN} = \frac{{C}_{K}}{{C}_{K max}} .$$

These and other advantages of the invention will be apparent to those of ordinary skill in the art by reference to the following detailed description and the accompanying drawings.

### BRIEF DESCRIPTION OF THE DRAWINGS

FIG. 1(a) is a block diagram of an object whose compactness is to be determined;

FIGS. 1(b)-1(d) are block diagrams of the object of FIG. 1(a) with a kernel expanding inside the object in accordance with an embodiment of the present invention;

FIG. 2 is a flowchart of the steps performed by a computer to determine the compactness of an object in accordance with an embodiment of the present invention;

FIG. 3 is a diagram of an object shaped like a “U” in accordance with an embodiment of the present invention; and

FIG. 4 shows a high level block diagram of a computer in accordance with an embodiment of the present invention.

### DETAILED DESCRIPTION

A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system, such as a computer aided design (CAD) system.

In accordance with an aspect of the present invention, to determine the compactness of an object, a simulation is performed with respect to the object. The simulation includes expanding the dimensions of a shape, referred to herein as a kernel, after inserting the kernel at the geographic center of the object. This simulation of expanding a kernel inserted at the geographic center of the object is performed on a digital object by a computer. The kernel has an initial size that is less than the size of the object itself.

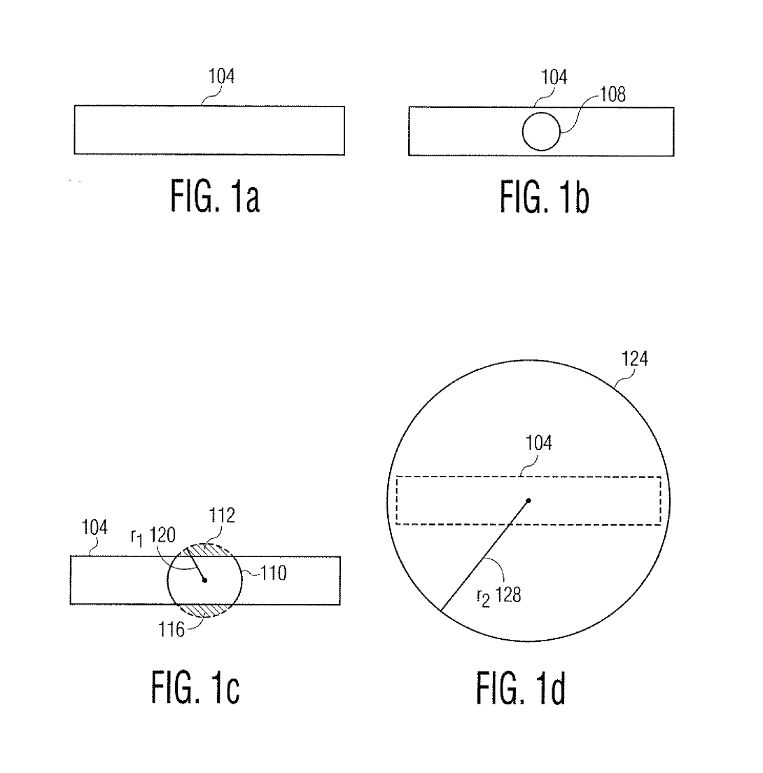

FIG. 1(a) is a block diagram of an object 104 whose compactness is to be determined. Although shown as a rectangle, the object 104 may be any shape and size. FIG. 1(b)-1(d) are block diagrams of object 104 with a kernel expanding inside the object 104 in accordance with an embodiment of the present invention.

Specifically, FIG. 1(b) shows the object 104 having a kernel 108 inside the object 104. In this embodiment, the kernel 108 is a small circle that is positioned at the geometric center of the object 104. The geometric center of the object 104 is a point at the middle of the object 104. Although described as a circle, the kernel can be any shape and/or size, such as a square.

The kernel 108 is then expanded (i.e., the dimensions are expanded) (e.g., at a predetermined rate). FIG. 1(c) shows kernel 110 inside the object 104. The kernel 110 has expanded with respect to kernel 108 such that a portion of the kernel 110 is outside of the object 104. The boundary of the portions 112, 116 of the kernel 110 that are outside of the object 104 are shown with dashed lines. The area of the portions 112, 116 are shown with diagonal lines.

In one embodiment, two measurements are needed to compute the object's compactness. First, the radius of the kernel when a predetermined amount of the kernel is first located outside of the original object 104 is determined. The predetermined amount of the kernel may be a percentage of the kernel or a number of pixels or voxels that are first located outside of the original object 104. For example, the predetermined amount can be set to at least one pixel/voxel. In one embodiment, the predetermined amount can be adjusted. The radius of the kernel when the kernel first completely overlaps the object 104 is then determined. The kernel first completely overlaps the object when the kernel has expanded such that the object is completely enclosed within the kernel

With respect to FIG. 1(c), radius r₁ 120 of kernel 110 is recorded. The dimensions of the kernel continue to be expanded until the kernel completely overlaps the original object 104, as shown with kernel 124 in FIG. 1(d). The object 104 is now completely overlapped by the kernel 124 and is shown with dashed lines. The kernel's radius r₂ 128 is recorded.

In accordance with an aspect of the present invention, the kernel is the only item considered in determining the compactness of the object 104 and not the object 104 itself. This makes the compactness determination immune to noise, as perturbations on the surface of the object will not affect the final calculations much, if at all.

In accordance with an aspect of the present invention, the kernel has to be able to expand the same amount (e.g., percentage) in every direction. For example, the dimensions of a two dimensional kernel can be expanded by 10% in the x and y directions. Examples of the kernel include, for instance, a circle and a square. If the kernel is a square, the radius described above (the radius that is measured for compactness and shown in FIGS. 1(c) and 1(d) as r₁ 120 and r₂ 128, respectively) can be a distance that changes uniformly as the kernel expands, such as the length of a side of the square. Thus, the radius as used herein is a distance that changes uniformly as the dimensions of the kernel expand.

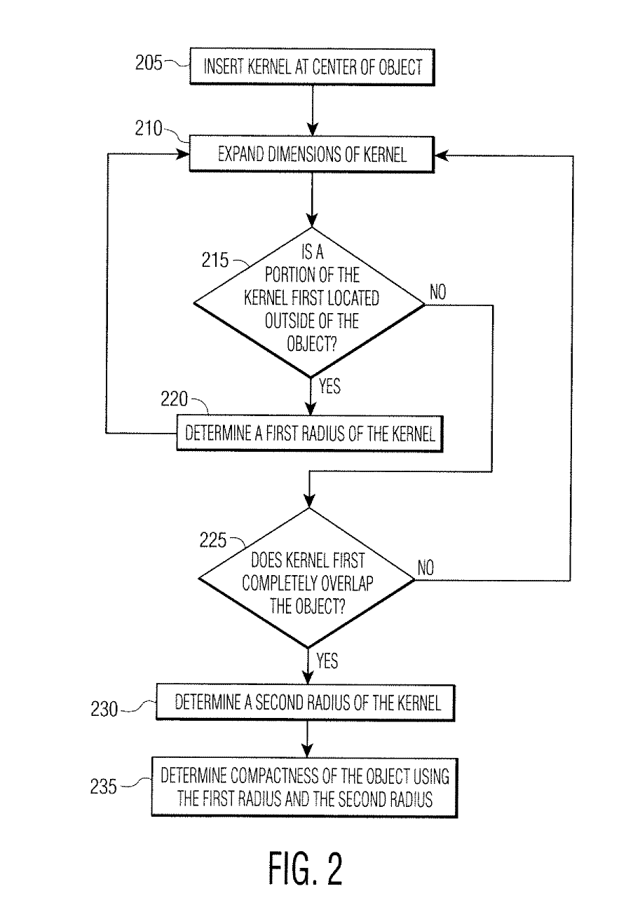

FIG. 2 shows a flowchart of the steps performed to determine the compactness of an object in accordance with an aspect of the present invention. A kernel is inserted (i.e., placed) at the geometric center of the object in step 205. The dimensions of the kernel are then (e.g., uniformly) expanded. When a portion (e.g., at least one pixel/voxel) of the kernel is first located outside of the object (determined in step 215), the kernel's radius is determined and stored in step 220. A portion of the kernel is first located outside the object when the portion (e.g., at least one pixel/voxel) is located outside of the object the first time. Thus, if the kernel continues to expand, the first radius is not determined multiple times. The first radius is only determined (and step 215 results in a Yes and progresses to step 220) once when the portion of the kernel is initially located outside of the object.

When the kernel first completely overlaps the object (determined in step 225), a second radius of the kernel is determined in step 230. The kernel first overlaps the object when the kernel overlaps the object the first time. Thus, after the kernel completely overlaps the object for the first time, the second radius is not determined again even if the kernel continues to expand. The second radius is only determined one time when the kernel initially overlaps the object.

In step 235, the determined radii are used to determine the compactness of the object. In one embodiment, the radius determined in step 225 (e.g., r₂) is subtracted from the radius determined in step 215 (e.g., r₁). In another embodiment, the formula

$$\frac{{r}_{2}^{2}}{{r}_{1}^{2}}$$

is used to determine compactness.

In one embodiment, the kernel compactness C_{K} is defined as

$$\frac{{r}_{2}}{{r}_{1}} .$$

In the 2D case, the least compact object would be an alignment of pixels. Therefore, the minimum compactness would be given by
C_{K min}=A (3)
with A being the area of the object. This represents the radius of the largest circle that would be needed if the object was a single row. Although it might not be needed, the same approach may be used for the maximum compactness, which is the smallest the kernel can be with a given object area

$${C}_{K max} = {r}_{max} = \sqrt{\frac{A}{\prod }} \qquad ( 4 )$$

Thus, the final compactness (normalized kernel compactness) can be given by either of the following two equations

$$\begin{matrix}{C}_{KN} = \frac{{C}_{K} - {C}_{K min}}{{C}_{K max} - {C}_{K min}} & ( 5 ) \\ {C}_{KN} = \frac{{C}_{K}}{{C}_{K max}} & ( 6 )\end{matrix}$$

With respect to a two dimensional object or a three dimensional object, the kernel has the same number of dimensions as the object (e.g., a circle, a sphere, a square, a cube, etc.).

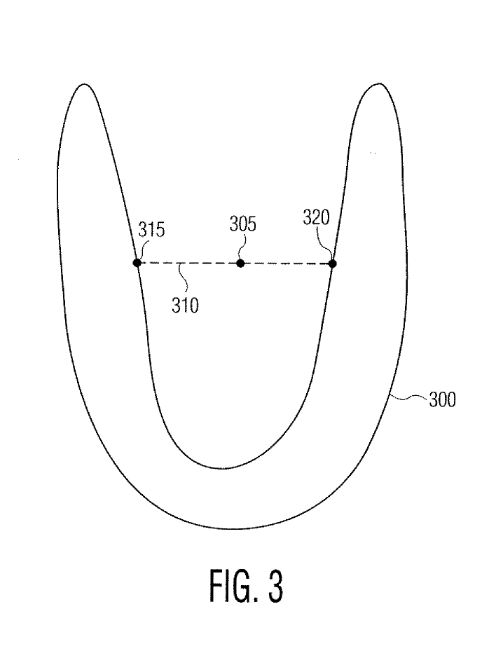

Although described above as the middle point of an object, the geometric center may alternatively be the midpoint of the object's medial axle (e.g., when the geometric center is not inside the object). FIG. 3 shows a diagram of an object 300 shaped like a “U”. The geometric center of the “U” is point 305 and is the midpoint of the object's medial axle 310. In this example, the kernel then starts outside of the object (i.e., at point 305). Additionally, the first radius (r₁) may be the radius at which the kernel begins to overlap the shape (e.g., points 315 and 320) (and the second radius (r₂) is as described above).

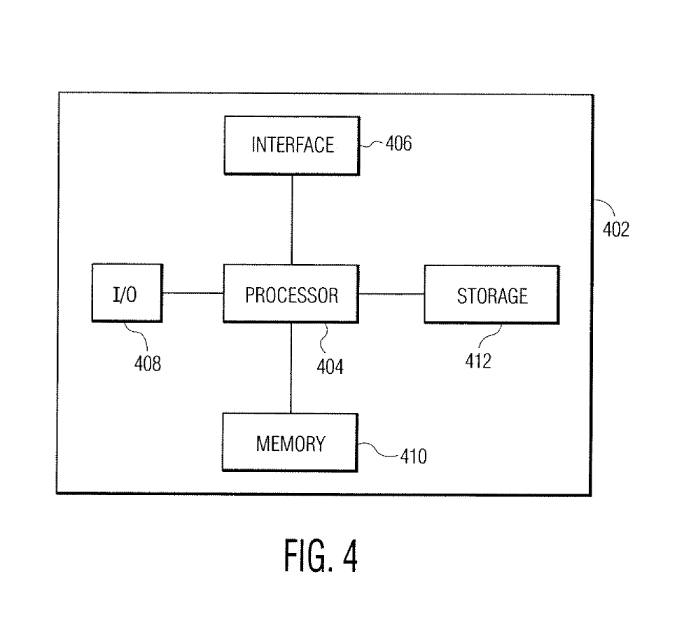

The description herewith describes the present invention in terms of the processing steps required to implement an embodiment of the invention. These steps may be performed by an appropriately programmed computer, the configuration of which is well known in the art An appropriate computer may be implemented, for example, using well known computer processors, memory units, storage devices, computer software, and other components. A high level block diagram of such a computer is shown in FIG. 4. Computer 402 contains a processor 404 which controls the overall operation of computer 402 by executing computer program instructions which define such operation. The computer program instructions may be stored in a storage device 412 (e.g., magnetic disk) and loaded into memory 410 when execution of the computer program instructions is desired. Computer 402 also includes one or more interfaces 406 for communicating with other devices (e.g., locally or via a network). Computer 402 also includes input/output 408 which represents devices which allow for user interaction with the computer 402 (e.g., display, keyboard, mouse, speakers, buttons, etc.).

One skilled in the art will recognize that an implementation of an actual computer will contain other components as well, and that FIG. 4 is a high level representation of some of the components of such a computer for illustrative purposes. In addition, one skilled in the art will recognize that the processing steps described herein may also be implemented using dedicated hardware, the circuitry of which is configured specifically for implementing such processing steps. Alternatively, the processing steps may be implemented using various combinations of hardware and software. Also, the processing steps may take place in a computer or may be part of a larger machine.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operation of an imaging system for determining the compactness of a digital representation of an object, said method comprising:
positioning a kernel at the center of said object, said kernel having dimensions that are initially smaller than dimensions of said object;
expanding said dimensions of said kernel;
determining a first radius of said kernel when a portion of said kernel is first located outside of said object;
determining a second radius of said kernel when said kernel first overlaps said object; and
determining compactness of said object using said first radius and said second radius

2. The method of claim 1 wherein said expanding said dimensions of said kernel further comprises uniformly expanding said dimensions of said kernel.

3. The method of claim 1 wherein said kernel is a circle.

4. The method of claim 1 wherein said kernel is a sphere.

5. The method of claim 1 wherein said kernel is a square.

6. The method of claim 1 wherein said kernel is a cube.

7. The method of claim 1 wherein said determining compactness further comprises subtracting said first radius from said second radius.

8. The method of claim 1 wherein said determining compactness further comprises determining
$$\frac{{r}_{2}^{2}}{{r}_{1}^{2}} ,$$
where r₂ is the second radius and r₁ is the first radius.

9. The method of claim 1 wherein said determining compactness further comprises determining a form based on r₁ and r₂, where r₂ is the second radius and r₁ is the first radius.

10. The method of claim 9 wherein said form further comprises
$$\frac{{r}_{2}^{n}}{{r}_{1}^{n}} ,$$
where n can be any real number.

11. The method of claim 1 wherein said determining compactness further comprises determining a minimum compactness C_{K min}=A, where A is area of said object.

12. The method of claim 9 wherein said determining compactness further comprises determining a maximum compactness
$${C}_{K max} = {r}_{max} = \sqrt{\frac{A}{\prod }} ,$$
where A is area of said object.

13. The method of claim 10 wherein said determining compactness further comprises determining a final compactness
$${C}_{KN} = \frac{{C}_{K} - {C}_{K min}}{{C}_{K max} - {C}_{K min}} , where {C}_{k} is \frac{{r}_{2}}{{r}_{1}} .$$

14. The method of claim 10 wherein said determining compactness further comprises determining a final compactness
$${C}_{KN} = \frac{{C}_{K}}{{C}_{K max}} , where {C}_{k} is \frac{{r}_{2}}{{r}_{1}} .$$

15. An apparatus for determining the compactness of a digital representation of an object comprising:
means for positioning a kernel at the center of said object, said kernel having dimensions that are initially smaller than said object;
means for expanding said dimensions of said kernel;
means for determining a first radius of said kernel when a portion of said kernel is first located outside of said object;
means for determining a second radius of said kernel when said kernel first overlaps said object; and
means for determining compactness of said object using said first radius and said second radius.

16. The apparatus of claim 15 wherein said means for expanding said dimensions of said kernel further comprises means for uniformly expanding said dimensions of said kernel.

17. The apparatus of claim 15 wherein said kernel is a circle.

18. The apparatus of claim 15 wherein said kernel is a sphere.

19. The apparatus of claim 15 wherein said kernel is a square.

20. The apparatus of claim 15 wherein said kernel is a cube.

21. The apparatus of claim 15 wherein said means for determining compactness further comprises means for subtracting said first radius from said second radius.

22. The apparatus of claim 15 wherein said means for determining compactness further comprises means for determining
$$\frac{{r}_{2}^{2}}{{r}_{1}^{2}} ,$$
where r₂ is the second radius and r₁ is the first radius.

23. The apparatus of claim 15 wherein said means for determining compactness further comprises means for determining a form based on r₁ and r₂, where r₂ is the second radius and r₁ is the first radius.

24. The apparatus of claim 23 wherein said form further comprises
$$\frac{{r}_{2}^{n}}{{r}_{1}^{n}} ,$$
where n can be any real number.

25. The apparatus of claim 15 wherein said means for determining compactness further comprises means for determining a minimum compactness C_{K min}=A, where A is area of said object.

26. The apparatus of claim 25 wherein said means for determining compactness further comprises means for determining a maximum compactness
$${C}_{K max} = {r}_{max} = \sqrt{\frac{A}{\prod }} ,$$
where A is area of said object.

27. The apparatus of claim 26 wherein said means for determining compactness further comprises means for determining a final compactness
$${C}_{KN} = \frac{{C}_{K} - {C}_{K min}}{{C}_{K max} - {C}_{K min}} , where {C}_{k} is \frac{{r}_{2}}{{r}_{1}} ,$$
r₂ is the second radius, and r₁ is the first radius.

28. The apparatus of claim 26 wherein said means for determining compactness further comprises means for determining a final compactness
$${C}_{K N} = \frac{{C}_{K}}{{C}_{K max}} , where {C}_{k} is \frac{{r}_{2}}{{r}_{1}} ,$$
r₂ is the second radius and r₁ is the first radius.

29. A computer readable medium comprising computer program instructions capable of being executed in a processor and defining the steps comprising:
positioning a kernel at the center of a digital representation of an object, said kernel having dimensions that are initially smaller than said object;
expanding said dimensions of said kernel;
determining a first radius of said kernel when a portion of said kernel is first located outside of said object;
determining a second radius of said kernel when said kernel first overlaps said object; and
determining compactness of said object using said first radius and said second radius.

30. The computer readable medium of claim 29 wherein said expanding step further comprises uniformly expanding said dimensions of said kernel.

31. The computer readable medium of claim 29 wherein said step of determining compactness further comprises subtracting said first radius from said second radius.

32. The computer readable medium of claim 29 wherein said step of determining compactness further comprises determining
$$\frac{{r}_{2}^{2}}{{r}_{1}^{2}} ,$$
where r₂ is the second radius and r₁ is the first radius.

33. The computer readable medium of claim 29 wherein said step of determining compactness further comprises determining a form based on r₁ and r₂, where r₂ is the second radius and r₁ is the first radius.

34. The method of claim 33 wherein said form further comprises
$$\frac{{r}_{2}^{n}}{{r}_{1}^{n}} ,$$
where n can be any real number.

35. The computer readable medium of claim 29 wherein said step of determining compactness further comprises determining a minimum compactness C_{K min}=A, where A is area of said object.

36. The computer readable medium of claim 35 wherein said step of determining compactness further comprises determining a maximum compactness
$${C}_{K max} = {r}_{max} = \sqrt{\frac{A}{Π}} ,$$
where A is area of said object.

37. The computer readable medium of claim 36 wherein said determining compactness further comprises determining a final compactness
$${C}_{K N} = \frac{{C}_{K} - {C}_{K min}}{{C}_{K max} - {C}_{K min}} , where {C}_{k} is \frac{{r}_{2}}{{r}_{1}} .$$

38. The computer readable medium of claim 36 wherein said step of determining compactness further comprises determining a final compactness
$${C}_{K N} = \frac{{C}_{K}}{{C}_{K max}} , where {C}_{k} is \frac{{r}_{2}}{{r}_{1}} .$$
